(19) United States
(12) Patent Application Publication
(10) Pub. No.: US 2026/0297966 A1
(43) Pub. Date: Oct. 1, 2026

(54) Temporary Step and Support

(71) Applicant: Matthew Burrow, Travelers Rest, SC (US)

(72) Inventor: Matthew Burrow, Travelers Rest, SC (US)

(21) Appl. No.: 19/705,949

(22) Filed: Jun. 12, 2026

Related U.S. Application Data
(63) Continuation-in-part of application No. 19/036,552, filed on Jan. 24, 2025.
Application No. 19/036,552 is a continuation of application No. 16/124,248, filed on Sep. 7, 2018, now abandoned.

(51) Int. Cl. E04G 27/00

(52) U.S. Cl. CPC E04G 27/00

(57) ABSTRACT

A temporary step and support assembly includes an attachment member and a step. Multiple sides of the attachment member are configured to engage a stud, board, or other fixed support. A first inwardly extending horizontal member with teeth is coupled to a lower edge of a first vertical side and extends outwardly to support a user. A second vertical side is coupled to the first vertical side, and a third vertical side is coupled to the second vertical side. A second inwardly extending horizontal member with teeth is coupled to a top edge of the third vertical side. The first and second inwardly extending horizontal members are disposed in different horizontal planes. Optional guide protrusions engage a wide face of a stud to maintain orientation. The assembly may be integrally formed from a single sheet of metal cut and bent to shape.

### CROSS REFERENCE TO RELATED APPLICATIONS

The present application is a continuation-in-part of U.S. application Ser. No. 19/036,552, entitled Temporary Step and Support filed on Jan. 24, 2025, which is a continuation of U.S. application Ser. No. 16/124,248, entitled Temporary Step and Support filed on Sep. 7, 2018. All of the foregoing applications are hereby incorporated by reference in their entireties.

### BACKGROUND OF THE INVENTION

The present invention generally relates to devices that may be attached to boards, studs, support beams to be used as a temporary step or support member. More specifically, the present invention includes a three-sided, rigid structure for attachment to a support structure that includes a horizontal surface for use as a step, or for use as a support mechanism.

In the construction industry, it is often necessary for a worker to work at a height that may be out of reach while the worker is standing on a floor or on ground level. Traditionally, a worker may employ a step stool, a ladder, scaffolding, or the like, in order to reach the area where such work is required. However, ladders are heavy and cumbersome, take up a lot of space, and have caused countless accidents. Step stools are smaller and easier to use, but they are frequently of little value because of their limited height. Scaffolding is heavy, expensive and time consuming to erect, and occupies an enormous amount of space.

Therefore, it would be desirable to provide a small, lightweight structure that may be temporarily attached to framing in a house or building, such as a two by four stud, or the like, which is easy to install and remove, and which is not heavy, expensive or cumbersome. Efforts to develop such a structure or system have been attempted with varying degrees of success.

For example, the following references disclose several types of such devices, and each of the references below is hereby incorporated by reference herein, in their entireties.

### U.S. Pat. No. 3,298,459 Tree Climbing Apparatus

This invention relates to apparatus for facilitating the climbing of trees and more particularly to tree climbing steps of the removable type particularly adapted for the use by sportsmen.

### U.S. Pat. No. 4,696,372 Portable Step and Carrying Device for Stud Wall

A portable step-forming device releasably attachable to a vertical wooden stud comprises a U-shaped gripping member for closely receiving a stud member, a step member attached to one prong of the U-shaped member and further having an enlarged end for retaining the user's foot on the step member, and a gripping means comprising a spring-loaded reciprocable member with a stud-engaging end for holding the step-forming device in position of the stud member.

### Pat. No. 3,561,563 Portable Post Step

An integral rigid catwalk metal sheet bent along a transverse fold line to provide a post engaging portion and a step portion, the post engaging portion having a laterally inwardly extending notch for engaging the post. The post is engaged by opposing edges of the notch wherein one of the edges is the inner edge portion of the step portion. The step is placed on the post from the side and the weight of the step portion will cause the unit to pivot downwardly bringing the opposing edges of the notch into engagement with the post thereby locking it in place. The post engaging portion forms an obtuse angle with the step portion and the step portion is normally positioned in a horizontal plane. A series of vertically spaced apart steps may be placed on a post and extend alternately from the post at angles of 90* to each other. Oppositely facing concave portions may be formed in the opposing edge portions for matingly engaging the rounded peripheral edge of a round post.

Each of the foregoing references are hereby incorporated herein by reference in their entirety.

### BRIEF SUMMARY OF THE INVENTION

In accordance with one aspect of the invention, a first embodiment of a temporary step and support assembly includes two primary portions: an attachment member and a horizontal surface member. The attachment member preferably includes three vertical sides for engaging a board or vertical support, wherein the first vertical side and the third vertical side are disposed in parallel relation, and the second vertical side is preferably angled upwardly from the first vertical side to the third vertical side. The horizontal surface member, in a preferred embodiment, is attached to the first vertical side of the attachment member, and serves as a temporary step, so that a user may attach the temporary step and support assembly to a vertical board for standing or climbing to reach a greater height in an upward direction.

The temporary step and support assembly may be attached to the board or support member in any suitable manner. In one embodiment, the first vertical side of the attachment member may define a threaded opening for receiving a screw or bolt. Optionally, the third vertical side of the attachment member may also define such a hole for receiving a screw or bolt. Alternatively (or along with other attachment configuration), one or more spikes or teeth may project from the first vertical side and/or third vertical side of the attachment member to temporarily secure the temporary step and support assembly to the vertical support.

In another embodiment, the horizontal surface member (step) is disposed outwardly from a top edge of a first vertical side. A first inwardly extending horizontally oriented member is coupled to a bottom edge of the first vertical side and extends inwardly in an opposed direction relative to the horizontal surface member. In a preferred embodiment, the first inwardly extending member includes a plurality of integrally formed teeth positioned along an inward edge portion thereof for engaging a stud. Optionally, a guide member may also extend inwardly adjacent the teeth on the first inwardly extending member. The guide member may include an inwardly directed protrusion terminating in a point, wherein the point is directed toward the stud and is configured to engage a wide face of the stud (e.g., the approximately three and a half inch to four-inch face of a 2×4 stud) to help maintain the temporary step and support assembly in a desired orientation during installation and use.

A second vertical side is attached to a vertical edge of the first vertical side and is oriented in a vertical plane. In the illustrated embodiment, the second vertical side includes a lower portion that extends generally horizontally in the vertical plane, an intermediate portion that extends angularly upwardly from the lower portion, and an upper portion that extends generally horizontally in the vertical plane. A third vertical side is attached to an opposed end of the second vertical side along a vertical edge thereof. A second inwardly extending horizontally oriented member extends inwardly from a top edge of the third vertical side and includes a plurality of teeth facing inwardly toward the first vertical side. Thus, the first and second inwardly extending members each include teeth that extend inwardly toward each other for engaging the stud, wherein the first inwardly extending member is positioned in a lower horizontal plane than the second inwardly extending member, such that the teeth engage the stud at vertically spaced locations.

In this embodiment, one or both of the first and second inwardly extending members may include an extension portion that extends inwardly past (and in the same direction as) the plurality of teeth. The extension portion may include an inwardly directed protrusion terminating in a point directed toward the stud and/or toward the second vertical side, wherein the point functions as a guide member for engaging the wide face of the stud to help maintain the assembly in proper alignment.

This embodiment may be manufactured from a single sheet of metal that is cut into a predetermined shape and then bent along a plurality of bend lines to form the temporary step and support assembly. In an embodiment, the assembly is formed from a single, monolithic piece of metal, wherein the metal is cut to define the step portion, the first, second, and third vertical side portions, the first and second inwardly extending member portions, the plurality of teeth, and any guide member features, and wherein the cut piece of metal is then bent along the lines shown therein to form this configuration

A series of temporary step and support assemblies may be attached to one or more boards or supports in order to provide a temporary ladder or a series of steps for a user to climb in lieu of a ladder, scaffolding, or a step stool. It should be understood that the device may be used not only for a step, but for other tasks, such as a support for tools, a place to hang a tool bag, or for any other desired purpose.

### BRIEF DESCRIPTION OF THE DRAWINGS

These and other features, aspects, and advantages of the present invention will become better understood with regard to the following description, appended claims, and accompanying drawings where:

FIG. 1 is a side view of one embodiment of the present invention, showing a temporary step and support assembly attached to a vertically oriented board;

FIG. 2 is a cutaway view of one embodiment of the present invention, showing a temporary step and support assembly attached to a vertically oriented board;

FIG. 3 is a cross-sectional top view of one embodiment of the present invention, showing a temporary step and support assembly attached to a vertically oriented board;

FIG. 4 is a cutaway front view of one embodiment of the present invention, showing two temporary step and support assemblies attached to a vertically oriented board;

FIG. 5 is a cutaway side view of another embodiment of the present invention, showing a temporary step and support assembly having the horizontal surface member pivotally attached to the attachment member via a hinge, and wherein the second vertical side extends beyond the edge of the first vertical side and includes a series of holes for receiving a securing pin mechanism for holding the horizontal surface member in a generally horizontal orientation;

FIG. 6 is a cutaway front view of the embodiment shown in FIG. 5 showing a temporary step and support assembly having the horizontal surface member pivotally attached to the attachment member via a hinge, and wherein the second vertical side extends beyond the edge of the first vertical side and includes a series of holes for receiving a securing pin mechanism for holding the horizontal surface member in a generally horizontal orientation;

FIG. 7 is a cutaway side view of the embodiment shown in FIG. 5 showing a temporary step and support assembly having the horizontal surface member pivotally attached to the attachment member via a hinge, and wherein the second vertical side extends beyond the edge of the first vertical side and includes a series of holes for receiving a securing pin mechanism for holding the horizontal surface member in a generally horizontal orientation;

FIG. 8 is a cutaway top view of the embodiment shown in FIG. 5 showing a temporary step and support assembly having the horizontal surface member pivotally attached to the attachment member via a hinge, and wherein the second vertical side extends beyond the edge of the first vertical side and includes a series of holes for receiving a securing pin mechanism for holding the horizontal surface member in a generally horizontal orientation;

FIG. 9 is a cutaway side view of one embodiment of the present invention, showing two temporary step and support assemblies with angularly adjustable horizontal surface member attached to an angularly oriented fixed support;

FIG. 10 is a perspective view of another embodiment of the present invention showing a horizontal surface member, a first vertical side, a second vertical side that includes a portion that is angled upwardly, and a third vertical side, wherein the first vertical side includes a set of teeth extending inwardly from a bottom edge thereof in a generally horizontal plane, and wherein the third vertical side includes a set of teeth extending inwardly from a top edge thereof, and further, wherein a guide member also extends inwardly and adjacent the teeth on both the first and third vertical sides;

FIG. 11 is another perspective view of the embodiment of the present invention shown in FIG. 10;

FIG. 12 is a front view of the embodiment of the present invention shown in FIG. 10;

FIG. 13 is a side view of the embodiment of the present invention shown in FIG. 10; and

FIG. 14 is a top view of a single, integrally formed flat piece of metal that has been cut to form the shape necessary to form the embodiment of the present invention shown in FIG. 10, wherein the flat piece of metal is bent along the lines shown to form the temporary step and support assembly.

### DETAILED DESCRIPTION OF THE INVENTION

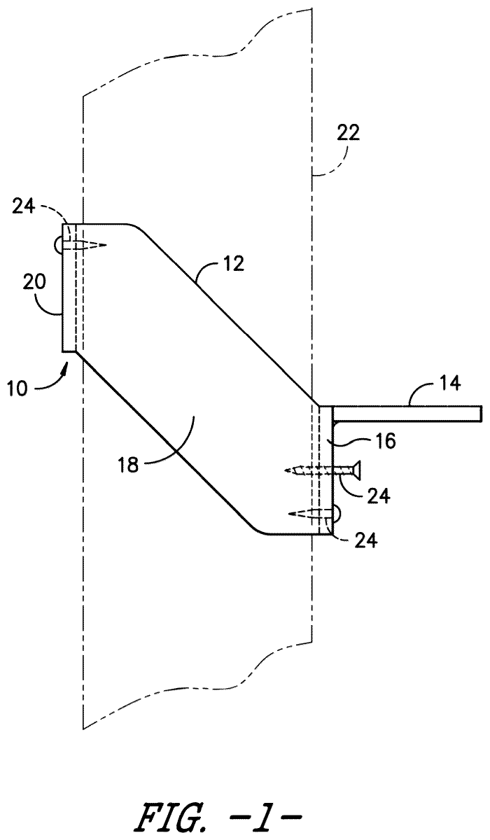

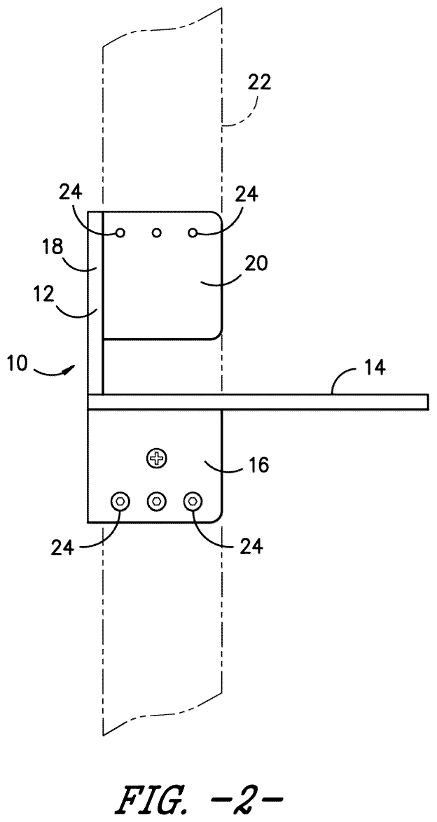

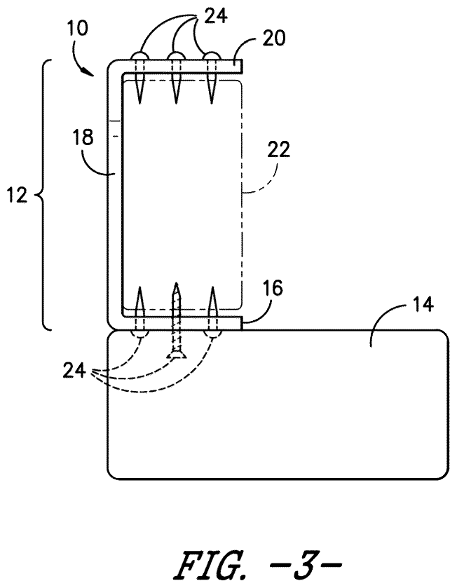

The present invention, in a first embodiment, includes a temporary step and support assembly 10 having two primary portions: an attachment member 12 and a horizontal support surface (or horizontal surface member) 14. The attachment member preferably includes three vertical sides for engaging a board or vertical support 22 (such as a framing stud in home construction), wherein the first vertical side 16 and the third vertical side 20 are disposed in offset parallel relation to one another on opposite sides of a vertical support member 22, and the second vertical side 18 is preferably angled upwardly from the first vertical side 16 to the third vertical side 20, as shown in FIGS. 1-4. The horizontal support surface 14, in a preferred embodiment, is attached to the first vertical side 16 of the attachment member 12, and serves as a temporary step, so that a user may attach the temporary step and support assembly 10 to a vertical board 22 for standing or climbing to reach a greater height in an upward direction.

For convenience, the following reference numerals correspond to the indicated components and features shown in the drawings and described herein:

### REFERENCE NUMERALS LIST

10—temporary step and support assembly
12—attachment member
14—horizontal surface member
16—first vertical side
18—second vertical side
20—third vertical side
22—vertical support member/board/stud
24—attachment configuration
30—securing pin
32—hinge
34—pin sleeve
36—head (of securing pin)
46—teeth (including teeth on each inwardly extending member)
48—inwardly extending guide member (optional)
54—lower portion of second vertical side
56—intermediate (angled) portion of second vertical side
58—upper portion of second vertical side
70—bend lines
72—Sheet of Metal/Monolithic Piece of Metal

Optionally, attachment configuration or device 24 may be provided, in order to temporarily secure the step and support assembly 10 to a vertical support member 22, such as an approximately 2 inch by 4 inch or an approximately 1.5 inch by 3.5 inch board or stud (collectively, hereinafter “2×4”). Attachment configuration 24 may include screws that extend through holes in the first vertical side and/or third vertical side of the attachment member 12 and into the vertical board 22, or the attachment device 24 may be protruding teeth, spikes, bolts, screws, nails, or any other suitable device, configuration, or arrangement for temporarily securing the attachment member 12 to the vertical board 22. If protruding teeth or spikes are used, they may be disposed perpendicularly or at an angle with respect to the planes of the first vertical side and/or third vertical side 16, 20 of the attachment member 12.

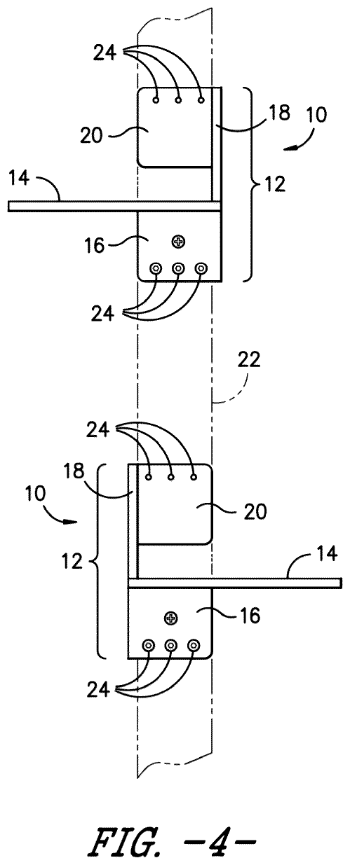

A series of step and support members 10 may be attached to vertical boards 22, in order to provide multiple steps, so that a user may climb upwardly on a house framing job, for instance, as shown in FIG. 4. The step and support assemblies 10 may be attached to the same board 22, or to different boards, as desired, to form a ladder, of sorts. This arrangement can be used instead of a ladder, step stool, or scaffolding, and is smaller, lighter, and occupies much less space than these alternatives.

In another embodiment, the step and support assembly 10 may be designed to be affixed to a stud or section of framing that is not vertically oriented, but rather, is oriented at an angle other than a vertical orientation, e.g., a roof rafter. In this embodiment, the horizontal surface member extends angularly from the attachment member so that when the attachment member is affixed to a board in an angular orientation (45 degrees, for instance), then the horizontal surface member is disposed in a generally horizontal orientation.

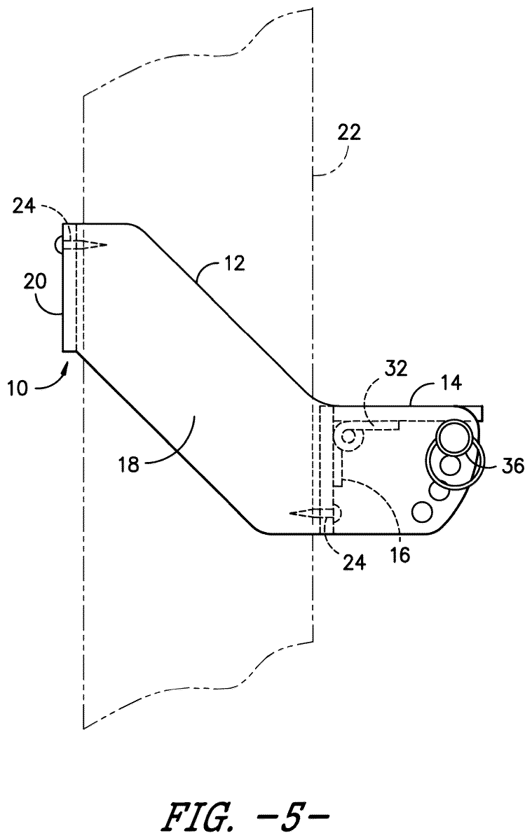

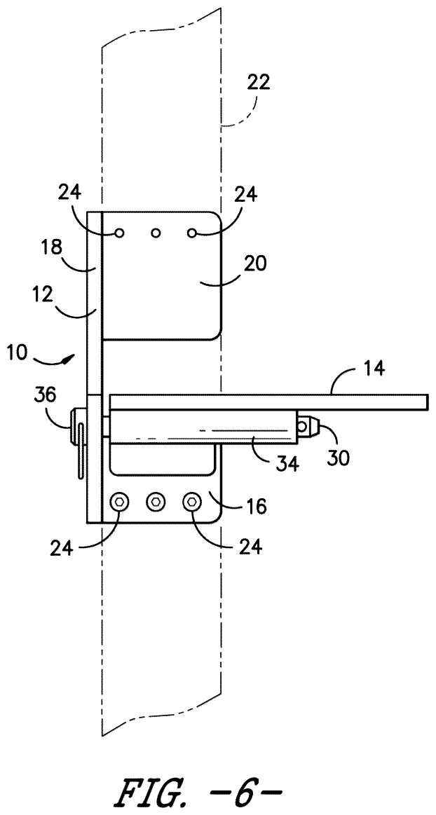

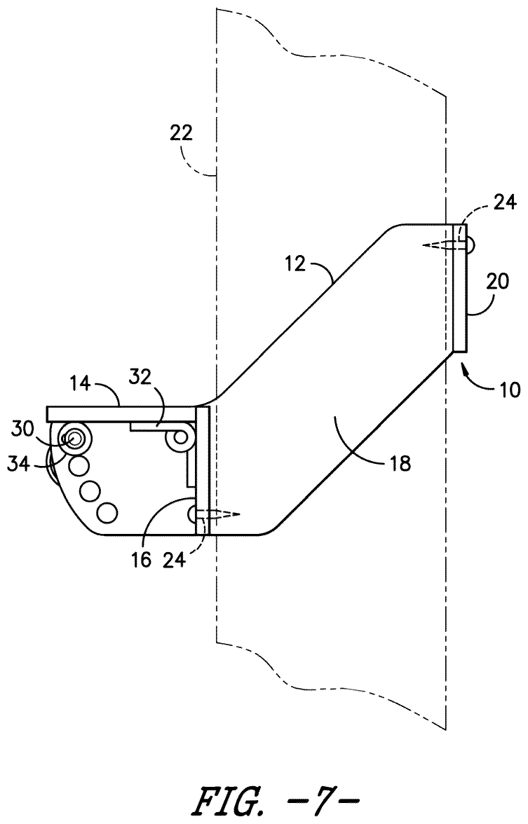

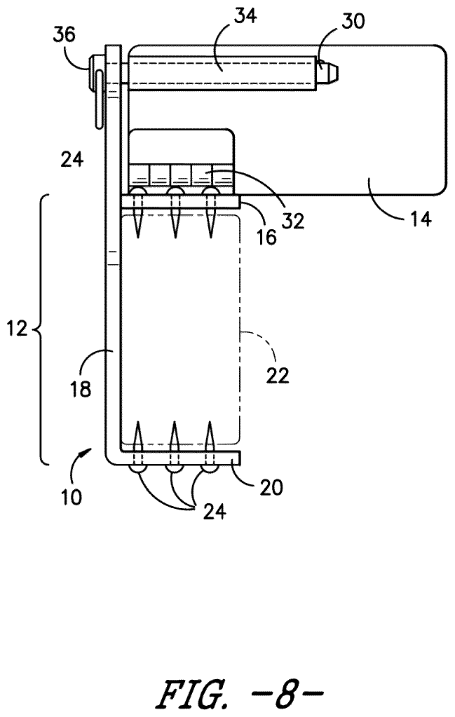

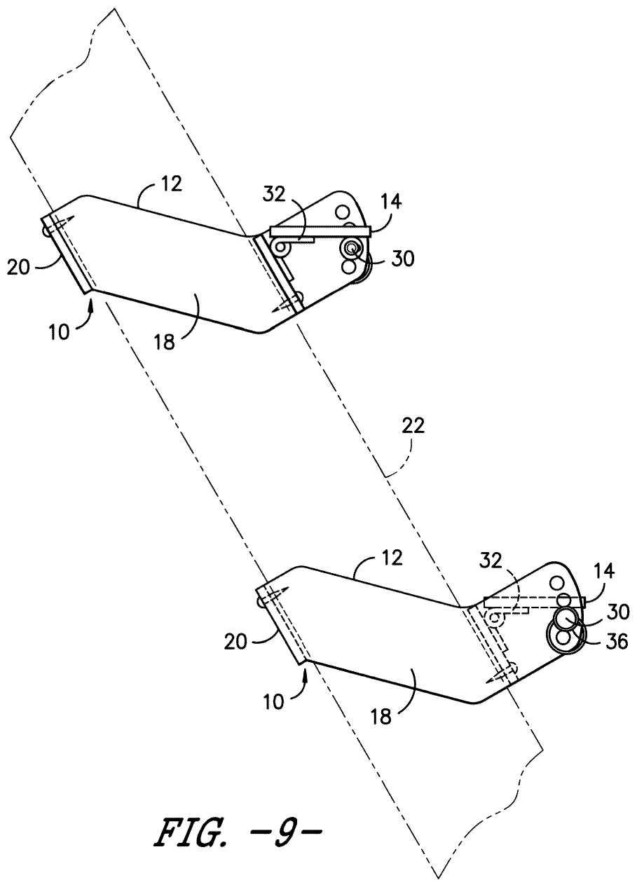

Optionally, the horizontal support surface 14 may be pivotally attached to the attachment member 12 to provide for an angular adjustment of the horizontal support surface 14, so that a user can attach the attachment member 12 to a board in an angular configuration (in other words, the board is not vertically oriented), and the user may then pivotally adjust the horizontal support surface 14 and secure it in a horizontal orientation. In this embodiment, as shown in FIGS. 5-9, the second vertical side 18 of the attachment member extends beyond the edge of the first vertical side 16 thereof, and includes a series of holes for receiving securing pins 30 or other securing device. The horizontal surface member 14 is affixed to the attachment member via a hinge 32, so that the horizontal surface member may be pivoted and adjusted to a generally horizontal position, and then secured in that generally horizontal position by inserting a pin into the appropriate hole beneath the horizontal surface member. The securing pin 30 may include a head 36 on one side thereof, and a pin sleeve 34 that snap fits onto an opposed side of the pin 30 in order to temporarily secure the pin 30 within the desired hole.

Optionally, the pin and holes may be threaded, so that the pin is screwed into the hole to secure the pin in place beneath the horizontal surface member for support. Other securing mechanisms or components may be used to temporarily support the horizontal surface member in a generally horizontal orientation, including bolts through the holes, snap-fit mechanisms, or other similar devices that are commonly used for such purposes and are well-known in the art.

The temporary step and support assembly 10 is preferably rigid, made from any suitable metal, high grade plastic or the like, and may be integrally formed or may be formed of multiple pieces and assembled. Although the function of the step and support assembly 10 has been described herein primarily as a step, it should be understood that the device 10 may also be used to support any desired item, including tools, tool bags, equipment, or any other item.

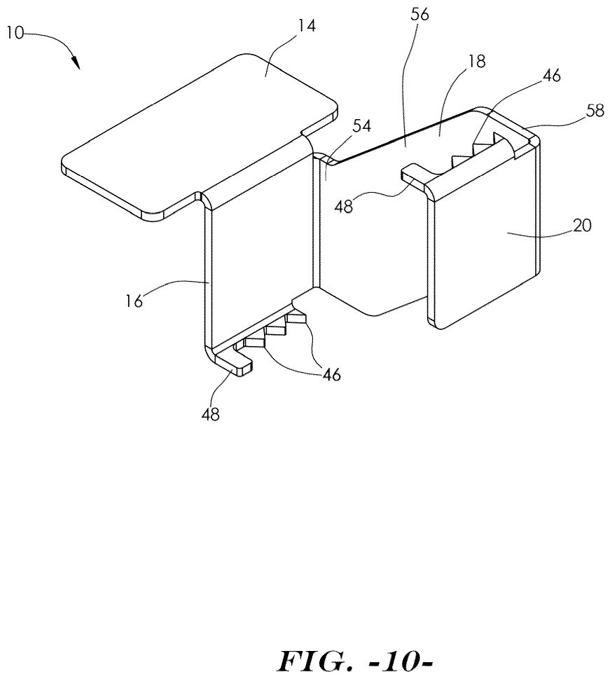

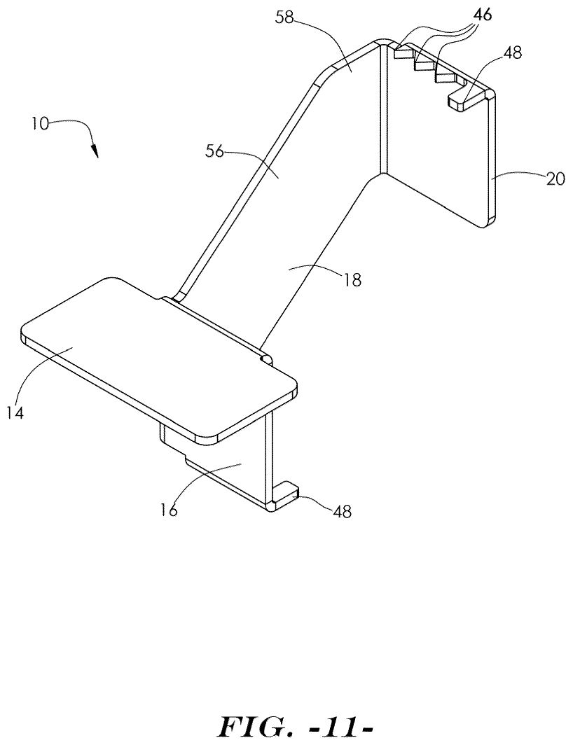

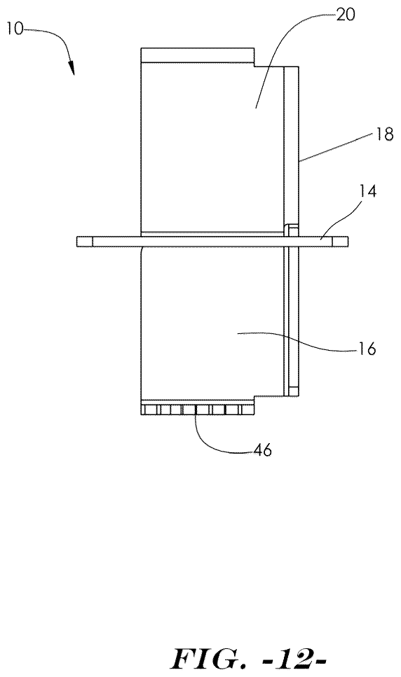

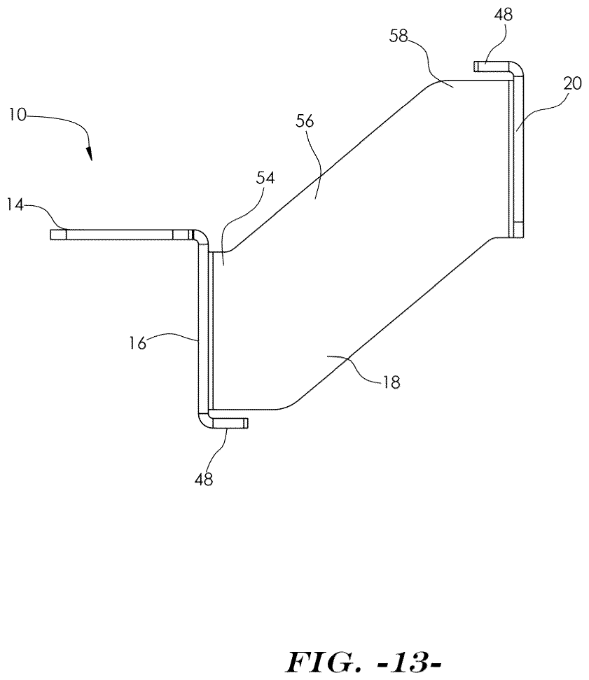

In another embodiment, as shown in FIGS. 10-14, the horizontal support surface (step) is disposed outwardly from a top edge of a first vertical side. A first inwardly extending horizontally oriented member is coupled to a bottom edge of the first vertical side and extends inwardly in an opposed direction relative to the horizontal support surface. In a preferred embodiment, the first inwardly extending member includes a plurality of integrally formed teeth 46 positioned along an inward edge portion thereof for engaging a stud. Optionally, a guide member 48 may also extend inwardly adjacent the teeth 46 on the first inwardly extending member. The guide member 48 may include an inwardly directed protrusion terminating in a point, wherein the point is directed toward the stud and is configured to engage a wide face of the stud (e.g., the approximately four-inch face of a 2×4) to help maintain the temporary step and support assembly in a desired orientation during installation and use.

A second vertical side is attached to a vertical edge of the first vertical side and is oriented in a vertical plane. In the illustrated embodiment, the second vertical side includes a lower portion 54 that extends generally horizontally in the vertical plane, an intermediate portion 56 that extends angularly upwardly from the lower portion 54, and an upper portion 58 that extends generally horizontally in the vertical plane. A third vertical side is attached to an opposed end of the second vertical side along a vertical edge thereof. A second inwardly extending horizontally oriented member extends inwardly from a top edge of the third vertical side and includes a plurality of teeth 46 facing inwardly toward the first vertical side. Thus, the first and second inwardly extending members each include teeth that extend inwardly toward each other for engaging the stud, wherein the first inwardly extending member is positioned in a lower horizontal plane than the second inwardly extending member, such that the teeth engage the stud at vertically spaced locations.

In this embodiment, one or both of the first and second inwardly extending members may include an extension portion that extends inwardly past (and in the same direction as) the plurality of teeth 46. The extension portion may include an inwardly directed protrusion terminating in a point directed toward the stud and/or toward the second vertical side, wherein the point functions as a guide member for engaging the wide face of the stud to help maintain the assembly in proper alignment.

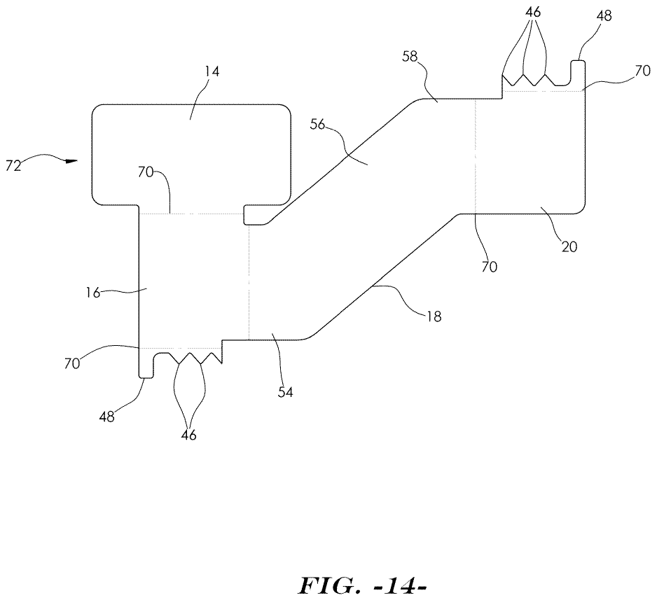

This embodiment may be manufactured from a single sheet of metal 72 that is cut into a predetermined shape and then bent along a plurality of bend lines 70 to form the temporary step and support assembly. In a preferred embodiment, the assembly is formed from a single, monolithic piece of metal, as shown in FIG. 14, wherein the metal is cut to define the step portion, the first, second, and third vertical side portions, the first and second inwardly extending member portions, the plurality of teeth, and any guide member features, and wherein the cut piece of metal is then bent along the lines shown therein to form the configuration shown in FIGS. 10-14.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A temporary step and support device for attachment to a board, stud, or other fixed support, comprising:
(a) a horizontal surface member defining a step;
(b) a first vertical side depending from the horizontal surface member;
(c) a first horizontally oriented member coupled to a lower edge of the first vertical side and extending inwardly;
(d) a second vertical side coupled to a vertical edge of the first vertical side, the second vertical side including an angularly upwardly extending portion;
(e) a third vertical side coupled to an opposed end of the second vertical side; and
(f) a second horizontally oriented member coupled to a top edge of the third vertical side and extending inwardly toward the first vertical side;
wherein at least one of the first horizontally oriented member and the second horizontally oriented member includes a plurality of teeth configured to engage a stud; and
wherein the temporary step and support device is integrally formed from sheet metal that is cut to a predetermined shape and bent along a plurality of bend lines to form the horizontal surface member, the first vertical side, the second vertical side, the third vertical side, and the first and second horizontally oriented members.

2. The device of claim 1, wherein the first horizontally oriented member includes a first plurality of teeth and the second horizontally oriented member includes a second plurality of teeth, the first and second pluralities of teeth being directed inwardly toward each other.

3. The device of claim 2, wherein the first horizontally oriented member is positioned in a lower horizontal plane than the second horizontally oriented member.

4. The device of claim 1, wherein the horizontal surface member is disposed outwardly from a top edge of the first vertical side.

5. The device of claim 1, wherein the plurality of teeth are integrally formed from material of the sheet metal.

6. The device of claim 1, wherein the second vertical side lies in a vertical plane and includes: (i) a lower portion extending generally horizontally in the vertical plane, (ii) an intermediate portion extending angularly upwardly from the lower portion, and (iii) an upper portion extending generally horizontally in the vertical plane, and wherein the third vertical side is coupled to the upper portion.

7. The device of claim 1, wherein the first and second horizontally oriented members are configured to clampingly engage opposed faces of the stud via the plurality of teeth.

8. The device of claim 1, further comprising an extension on an outer portion of at least one of the first horizontally oriented member and the second horizontally oriented member, the extension extending past the plurality of teeth in the same direction as the plurality of teeth.

9. The device of claim 8, wherein the extension includes an inwardly directed protrusion terminating in a point.

10. The device of claim 9, wherein the point is directed toward the second vertical side and is configured to engage a wide face of the stud as a guide member to maintain the temporary step and support device in a predetermined orientation relative to the stud.

11. The device of claim 1, wherein the first horizontally oriented member extends inwardly in a direction opposed to a direction the horizontal surface member extends outwardly.

12. The device of claim 1, wherein the device comprises a single, monolithic piece of sheet metal.

13. A method of manufacturing a temporary step and support device, comprising:
(a) providing a single sheet of metal;
(b) cutting the single sheet of metal to form a unitary blank having a step portion, a first side portion, a second side portion, a third side portion, a first flange portion, and a second flange portion; and
(c) bending the unitary blank along a plurality of bend lines to form a horizontal support surface, a first vertical side, a second vertical side, a third vertical side, a first horizontally oriented member, and a second horizontally oriented member, thereby forming the temporary step and support device as a single, integrally formed sheet-metal structure.

14. The method of claim 13, wherein the cutting of the single sheet of metal forms a plurality of teeth in at least one of the first flange portion and the second flange portion.

15. The method of claim 14, wherein the bending of the unitary blank orients the plurality of teeth to face inwardly toward a stud-receiving region.

16. The method of claim 14, wherein the cutting forms a first plurality of teeth in the first flange portion and a second plurality of teeth in the second flange portion.

17. The method of claim 16, wherein the bending positions the first flange portion in a lower horizontal plane than the second flange portion, such that the first plurality of teeth and the second plurality of teeth face inwardly toward each other.

18. The method of claim 13, wherein the bending forms the horizontal surface member disposed outwardly from a top edge of the first vertical side.

19. The method of claim 13, wherein the bending forms the second vertical side lying in a vertical plane and including a lower portion, an intermediate portion extending angularly upwardly from the lower portion, and an upper portion, and further forms the third vertical side coupled to the upper portion.

20. The method of claim 13, wherein the cutting forms, on an outer portion of at least one of the first flange portion and the second flange portion, an extension region that, after bending, extends past the plurality of teeth and includes an inwardly directed protrusion terminating in a point.
